(19) United States
(12) Patent Application Publication
(10) Pub. No.: US 2019/0283524 A1
(43) Pub. Date: Sep. 19, 2019

(54) METHOD AND SYSTEM FOR IMPROVING VEHICLE CABIN AIR QUALITY

(71) Applicant: Continental Automotive Systems, Inc., Auburn Hills, MI (US)

(72) Inventor: Eric Kopfstein, Vernon Hills, IL (US)

(21) Appl. No.: 15/923,002

(22) Filed: Mar. 16, 2018

(51) Int. Cl. B60H 1/00

(52) U.S. Cl. CPC B60H 1/008; B60H 1/00785; B60H 1/00764; B60H 1/00849

(57) ABSTRACT

A process for controlling a cabin air recirculation system includes comparing at least one air quality parameter of exterior air with a corresponding air quality parameter determined by at least one sensor interior to a cabin of a vehicle. The air quality parameter of the exterior air is determined at least partially based on a sensed condition from at least one sensor external to a vehicle. Engaging an air recirculation system occurs when a quality of air exterior to the vehicle is less than a quality of air within the cabin.

### TECHNICAL FIELD

The present disclosure relates generally to vehicle cabin air recirculation systems, and more specifically to a system for improving vehicle cabin air quality via sensing exterior air quality and automatically responding to the sensed information.

### BACKGROUND

Vehicles such as cars, trucks, and the like, include cabin air systems that recirculate air throughout the cabin. One feature commonly present in such systems is a way for the cabin air system to ingest outside air to refresh the cabin air. In some instances, however, the outside air can be less desirable than the current air inside the cabin. By way of example, if the vehicle is traveling behind another vehicle that is outputting a substantial amount of pollution then the outside air in the immediate vicinity of the vehicle is less fresh than the air currently within the cabin and ingestion of the outside air would decrease the quality of the air in the cabin.

Conventional cabin air quality control systems either monitor the quality of the air that is ingested into the vehicle's air systems or the quality of the air currently in the vehicle cabin. Under either of these approaches, however, at least a portion of the lower quality air has already entered the cabin air system prior to any reaction to the low quality air, and the cabin air system continuously recirculates the poor quality air.

### SUMMARY OF THE INVENTION

In one exemplary embodiment a process for controlling a cabin air recirculation system includes comparing at least one air quality parameter of exterior air with a corresponding air quality parameter determined by at least one sensor interior to a cabin of a vehicle, wherein the air quality parameter of the exterior air is determined at least partially based on a sensed condition from at least one sensor external to a vehicle, and engaging an air recirculation system when a quality of air exterior to the vehicle is less than a quality of air within the cabin.

In one exemplary embodiment a vehicle includes a plurality of exterior sensors configured detect at least one parameter exterior to the vehicle, at least one interior air quality sensor configured to detect at least one air quality parameter of air contained within a cabin of the vehicle, a controller communicatively coupled to each of the plurality of exterior sensors and the at least one interior sensor such that the controller receives sensor signals output by each of the exterior sensors in the plurality of exterior sensors and the at least one interior sensor, the controller including at least a processor and a memory, a cabin air recirculation system configured to operate in at least an induction mode and a recirculation mode, and the memory storing instructions configured to cause the controller to perform the process of comparing at least one air quality parameter determined at least partially based on a sensed condition from a sensor external to a vehicle with a corresponding air quality parameter determined by at least one sensor interior to a cabin of the vehicle, and engaging an air recirculation system when a quality of air exterior to the vehicle is less than a quality of air within the cabin.

These and other features of the present invention can be best understood from the following specification and drawings, the following of which is a brief description.

### BRIEF DESCRIPTION OF THE DRAWINGS

FIG. 1 schematically illustrates an exemplary vehicle including a cabin air recirculation system.

FIG. 2 illustrates a process for operating the cabin air recirculation system of FIG. 1.

### DETAILED DESCRIPTION OF AN EMBODIMENT

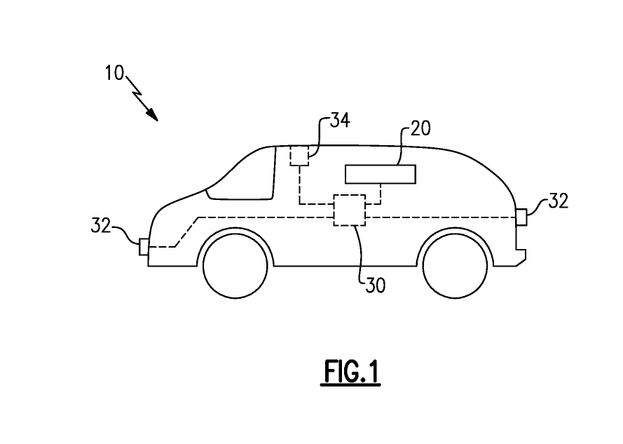

FIG. 1 schematically illustrates an exemplary vehicle 10, such as a car. The vehicle 10 includes a cabin air recirculation system 20. The cabin air recirculation system 20 is controlled via a vehicle controller 30. In the illustrated example, the vehicle controller 30 is a general controller that controls multiple different aspects of the vehicle 10. In alternative examples, the controller 30 is a cabin air controller and controls only the cabin air systems including the cabin air recirculation system 20. In the alternative example, the controller 30 can be further connected to, and in communication with, a general vehicle controller, or a system of additional controllers each of which controls various systems throughout the vehicle 10.

Connected to the controller 30 are multiple exterior sensors 32, and at least one interior sensor 34. The exterior sensors 32 are configured to detect at least one air quality parameter of the air exterior to the vehicle 10. In one example, the exterior sensors 32 include one or more optical sensor configured to determine a clarity of the air ahead of or behind the vehicle 10 based on a detected image. In another example, the exterior sensors 32 can include radar sensors, infrared sensors, or any similar sensor. In yet another example, the exterior sensors 32 can include a combination of any existing sensor types. The at least one interior sensor 34 can also be any sensor type and is used to determine internal cabin air quality according any known cabin air quality determination technique.

During operation of the vehicle 10, and using the data from the exterior sensors 32 and the at least one interior sensor 34, the controller 30 utilizes the exterior sensors 32 to detect existing pollution events and the controller 30 to predict potential upcoming pollution events based on an evaluation of the environment surrounding the vehicle 10 prior to any ingestion of the exterior air. By way of example, pollution events can include approaching a construction dust cloud, approaching a fog bank, traveling behind a vehicle emitting or likely to emit substantial pollution, or any similar detectable and predictable event. The exterior sensors 32 can include existing vehicle-mounted cameras, such as those present to facilitate autonomous driving, braking, cruise control, etc., or from cameras custom designed for pollution detection.

One method of utilizing the exterior sensors 32 to detect existing pollution events is through the utilization of optical exterior sensors 32. In such an example, an image processing scheme stored in the controller 30 analyzes the signals originating from the optical exterior sensors 32 for visual indications of contaminants. In some examples the contaminants can include smoke (diesel fumes, oily exhaust, etc.), haze from dust, etc. Upon detecting such conditions, the controller 30 causes the cabin air recirculation system 20 to be switched to recirculation mode, if the cabin air recirculation system 20 is not already in the recirculation mode. This command occurs automatically without intervention from a driver or other occupant of the vehicle and prevents ingestion of the exterior air. Once the adverse conditions are no longer detected by the controller 30, the controller 30 commands the cabin air recirculation system 20 to disengage recirculation and resume ingesting exterior air. Potential false triggers, such as haze due to fog, is minimized via the integration of inputs from other sensors, such as those for humidity and through additional processing of the signals from the exterior sensors 32 by the controller 30.

In another example, where the controller 30 is configured to predict an upcoming pollution event, the controller 30 uses information from the exterior sensors 32, and the interior sensor 34 to determine when a pollution event is likely to occur. This is referred to as a predictive mode. For instance, the elevated exhaust pipe on many busses, and similar vehicles, is positioned at a height that efficiently pumps pollutants into the air intake of passenger vehicles immediately behind the bus. When trailing a bus in close proximity, such as in stop-and-go traffic, the controller 30 analyzes an image from an optical exterior sensor 32 to determine whether a bus-like vehicle is present. If a bus-like vehicle is present, the controller 30 searches the sensed image for a tailpipe-like structure within a potentially hazardous zone and automatically switches to recirculation mode when both conditions are true.

The controller 30 can also integrate vehicle speed into the analysis, reducing a recirculation initiation threshold as vehicle speed increases. The analysis can include multiple simultaneous speed thresholds, each corresponding to a different predicted pollution event. Other scenarios where pollution is likely to occur, such as those related to the presence of heavy trucks, approaching a smoke cloud or smog field, and the like can also be incorporated into the logic within the controller 30 in a similar manner.

In some examples, the controller 30 can also perform a comparison of a current in-cabin air state, as detected by the at least one internal sensor 34, to the quality of the air detected by the exterior sensors 32 outside the vehicle 10 or predicted by the controller 30. The controller 30 utilizes the comparison to determine whether to prioritize recirculation of air in the cabin or induction of outside air into the cabin. By way of example, if the contaminant level in the cabin of the vehicle 10, as detected by the internal sensor 34, is high then the controller 30 can determine that outside air should continue to be introduced, despite the detection of an outside pollution event.

In some further configurations, where the air recirculation system 20 supports the feature, the controller 30 can utilize a more graduated recirculation approach, as opposed to a simple recirculation on/off behavior. By way of example, the controller 30 can determine a desirable quantity or percentage of air to ingest from outside, and valves within the air recirculation system 20 can control the mixture of recirculated air and ingested air. Depending on the severity of pollution optically detected or predicted, the controller 30 may engage a range of recirculation, from partial to full.

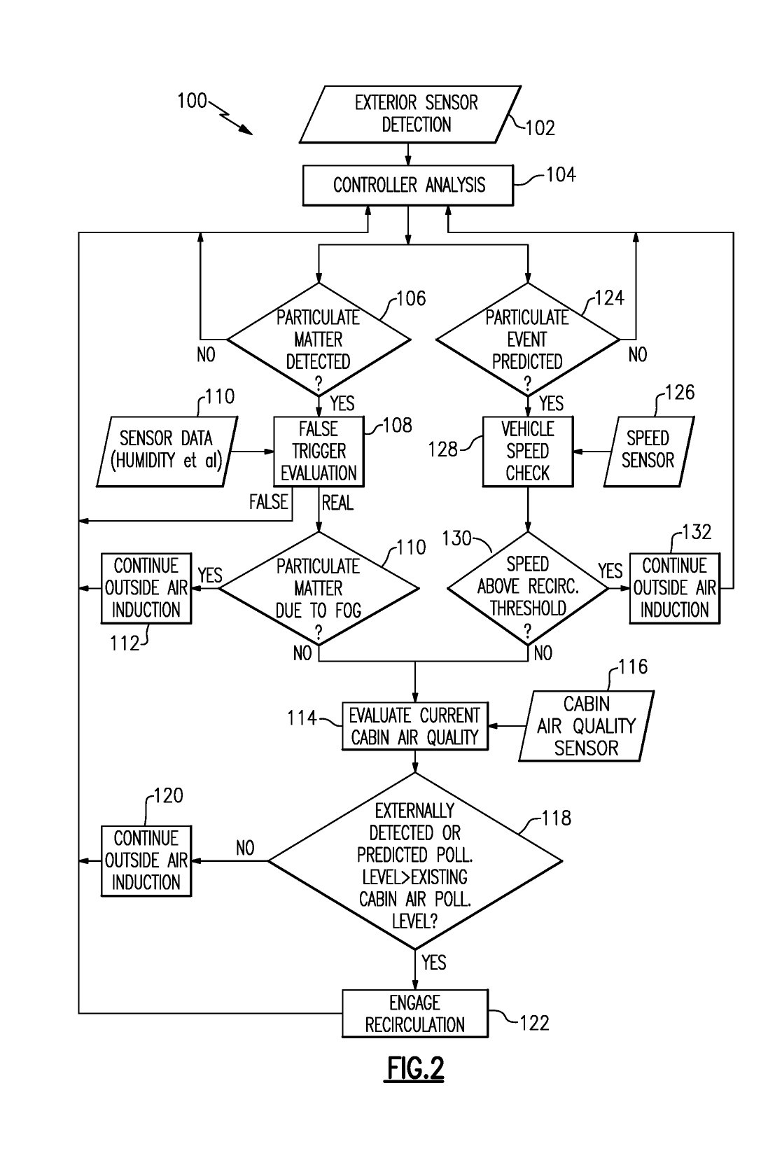

With continued reference to FIG. 1, FIG. 2 schematically illustrates an exemplary process 100 for implementing the air recirculation scheme described above with regards to FIG. 1. Initially, the exterior sensors 32 report at least one air quality parameter to the controller 30 during exterior sensor detection 102, and the controller 30 determines the air quality based on the reported parameter at a controller analysis 104. The controller analysis 104 can result in multiple paths each of which can take place independently or simultaneously.

A first path uses the controller analysis 104 to determine if any particulate matter was detected at a particulate matter detected check 106. If no particulate matter was detected in the air outside of the vehicle 10, than the first path returns to the controller analysis 104, and the process is reiterated. If particulate matter is detected via the controller 30, the process 100 checks to determine if the detection is accurate, or is the result of a false trigger, in a false trigger evaluation 108. The false trigger evaluation 108 can include any known process for checking for a false positive. In certain examples, the false trigger evaluation 108 incorporates known conditions, such as humidity, temperature, etc. that can impact the sensor readings via incorporation of sensor data 110 from one or more sensors 32, 34.

If the particulate matter detection is false, the process 100 returns to the controller analyses 104, and the process 100 is reiterated. If the false trigger evaluation 108 determines that the particulate matter detection 108 was accurate, the process 100 checks to determine if the particulate matter is due to fog, or other evaporated moisture, in a particulate matter due to fog check 110. When it is determined that the particulate matter is due to fog, and not due to a pollution event, the process 100 continues induction of outside air in a continue induction of outside air step 112, and returns to the controller analysis 104.

If the particulate matter is not due to fog, the process 100 proceeds to an evaluate current cabin air quality check 114. In the evaluate current cabin air quality check 114, the at least one internal sensor 34 provides parameters corresponding to the quality of the air already inside the vehicle 10 to the controller 30 in a cabin air quality sensor reading 116. Once the internal cabin air parameters have been determined, the controller 30 compares the quality of the air outside with the quality of the air inside the vehicle 10 in a externally detected or predicted pollution level greater than existing cabin air pollution level check 118.

If the air outside of the vehicle 10 is less polluted than the air within the cabin, then the controller 30 continues outside air induction 120, and returns to the controller analysis 104 to reiterate the process. If the air inside the cabin is less polluted than the air outside of the cabin, then the controller 30 engages the cabin air recirculation system 20 in an engage recirculation step 122, and returns to the controller analysis 104 to reiterate the process 100.

Simultaneous with, or independent of, the particulate matter detection 106, the process 100 can predict whether a pollution event is about to occur based on the controller analysis 104 in a pollution event predicted check 124. The prediction path is the second path of the process 100. If no pollution event is predicted the process 100 returns to the controller analysis 104 to reiterate the process.

If a pollution event is predicted, the controller 30 receives a vehicle speed sensor input 126 from at least one speed sensor and determines the vehicle speed in a vehicle speed check 128. Once the speed is determined, the controller checks to see if the speed is above a threshold in an is speed above recirculation threshold check 130. The particular threshold can be set depending on the characteristics of the vehicle 10, and can vary depending on the type of predicted pollution event. By way of example, a speed threshold may be at a first level for a temporary pollution event such as driving past a construction site and at a second level for a prolonged pollution event such as driving behind a vehicle such as a bus.

If the vehicle speed is above the corresponding vehicle speed threshold, the controller 30 determines that the vehicle 10 is going fast enough that continued ingestion of outside air will either not result in ingestion of the predicted pollution, or the ingestion will be short enough as to not create undesirable air quality within the vehicle. Once this determination has been made, the process 100 proceeds to a continue outside air induction step 132 and returns to the controller analysis 104 to reiterate the process 100.

If the speed is not above the corresponding recirculation threshold, the process proceeds to evaluate the cabin air quality, in the evaluate cabin air quality step 114, and proceeds as described above with regards to the first path.

While described above as an automatic process 100, by which the controller 30 switches between a recirculation mode and an outside air induction mode, it should be appreciated that alternative modes can exist. By way of example, in one mode the controller 30 can provide a prompt informing the vehicle 10 operator that switching to recirculation mode can improve the cabin air quality. In such an example, the operator can then respond by manually switching to recirculation mode. The alternative allows the operator to provide an override and further mitigate potential false predictions.

In yet another alternative, the process 100 can inform the vehicle operator that an automatic switch to induction or recirculation mode has occurred. The operator can then determine if a manual override is necessary or warranted and perform the manual override should the circumstances dictate.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A process for controlling a cabin air recirculation system comprising:
comparing at least one air quality parameter of exterior air with a corresponding air quality parameter determined by at least one sensor interior to a cabin of a vehicle, wherein the air quality parameter of the exterior air is determined at least partially based on a sensed condition from at least one sensor external to a vehicle; and
engaging an air recirculation system when a quality of air exterior to the vehicle is less than a quality of air within the cabin.

2. The process of claim 1, wherein engaging the air recirculation system comprises automatically engaging the air recirculation system in response to the quality of the air exterior to the vehicle being less than the quality of air within the cabin.

3. The process of claim 2, further comprising notifying a vehicle operator that the air recirculation system has been engaged and allowing the vehicle operator to manually override the air recirculation system.

4. The process of claim 1, wherein engaging the air recirculation system comprises notifying a vehicle operator of the air quality determination and engaging the air recirculation system in response to the vehicle operator manually starting the air recirculation system.

5. The process of claim 1, wherein the at least one air quality parameter of exterior air is determined at least in part by an analysis of an image from an optical sensor.

6. The process of claim 5, wherein the at least one air quality parameter is a clarity of the air.

7. The process of claim 1, wherein determining the at least one air quality parameter of exterior air includes predicting an upcoming pollution event.

8. The process of claim 7, wherein predicting an upcoming pollution event comprises analyzing at least one image and determining a presence of a potentially hazardous condition.

9. The process of claim 7, further comprising comparing a speed of the vehicle to a speed threshold corresponded to the determined potentially hazardous condition and engaging the air recirculation system when the speed of the vehicle is below the threshold.

10. The process of claim 9, wherein a controller stores at least two distinct speed thresholds, each of the distinct speed thresholds corresponding to a distinct type of potentially hazardous condition.

11. The process of claim 1, wherein comparing the at least one air quality parameter of exterior air with the corresponding air quality parameter determined by the at least one sensor interior to a cabin of the vehicle, comprising determining whether the vehicle is traveling at a speed above a speed threshold.

12. The process of claim 1, further comprising evaluating the at least one air quality parameter of exterior air via a false trigger evaluation, and preventing engagement of the air recirculation system when a false trigger is detected.

13. The process of claim 12, wherein the false trigger evaluation includes analysis of a humidity sensor reading, and wherein the humidity sensor is one of the at least one sensors external to the vehicle.

14. The process of claim 1, wherein engaging the air recirculation system when the quality of air exterior to the vehicle is less than the quality of air within the cabin comprises recirculating a portion of the air within the cabin, and ingesting a portion of the air exterior to the vehicle.

15. A vehicle comprising:
a plurality of exterior sensors configured detect at least one parameter exterior to the vehicle;
at least one interior air quality sensor configured to detect at least one air quality parameter of air contained within a cabin of the vehicle;
a controller communicatively coupled to each of the plurality of exterior sensors and the at least one interior sensor such that the controller receives sensor signals output by each of the exterior sensors in the plurality of exterior sensors and the at least one interior sensor, the controller including at least a processor and a memory;
a cabin air recirculation system configured to operate in at least an induction mode and a recirculation mode; and
the memory storing instructions configured to cause the controller to perform the process of comparing at least one air quality parameter determined at least partially based on a sensed condition from a sensor external to a vehicle with a corresponding air quality parameter determined by at least one sensor interior to a cabin of the vehicle, and engaging an air recirculation system when a quality of air exterior to the vehicle is less than a quality of air within the cabin.

16. The vehicle of claim 15, wherein the plurality of exterior sensors include at least one optical sensor.

17. The vehicle of claim 15, wherein the controller is a general vehicle controller.

18. The vehicle of claim 15, wherein the controller is a dedicated air recirculation system controller.
